(19) United States
(12) Patent Application Publication
(10) Pub. No.: US 2014/0137564 A1
(43) Pub. Date: May 22, 2014

(54) Mitigation of Hot Corrosion in Steam Injected Gas Turbines

(71) Applicant: GENERAL ELECTRIC COMPANY, Schenectady, NY (US)

(72) Inventors: Alston I. Scipio, Atlanta, GA (US); Sanji Ekanayake, Atlanta, GA (US); Paul Robert Fernandez, Atlanta, GA (US)

(73) Assignee: GENERAL ELECTRIC COMPANY, Schenectady, NY (US)

(21) Appl. No.: 13/680,679

(22) Filed: Nov. 19, 2012

(51) Int. Cl. F02C 3/30; F02C 9/00

(52) U.S. Cl. CPC F02C 3/30; F02C 9/00
USPC 60/775; 60/39.53

(57) ABSTRACT

Systems and methods for mitigation of hot corrosion in steam injected gas turbine. In one embodiment, a steam injection system can provide for automatic injection of steam in a gas turbine for NOx abatement and power augmentation. The system can obtain indications as to whether the steam to be injected meets the requirements of the gas turbine in terms of purity and quality. If the quality or purity is not adequate, steam the injection into the combustor or compressor discharge casing (CDC) is automatically inhibited. The system may also monitor the dynamic pressure oscillations inside the combustor. The system may modulate steam flows modulates to enhance the total steam flow while maintaining the dynamic oscillations within acceptable limits.

### FIELD OF DISCLOSURE

This disclosure relates generally to gas turbines, and more specifically to mitigation of hot corrosion in steam injected gas turbines.

### BACKGROUND

Steam injection for power augmentation and NOx (nitric oxide) abatement has been an available option with combustion turbines for many years. The underlying strategy of steam injection for NOx reduction is to cool the combustion flame temperature to reduce the formation of NOx. Increasing the turbine's mass flow increases its power output.

Under the conditions of high pressure and temperature of today's power plant, the problem of steam solubility of inorganic compounds is increasingly important. Field data shows that the hot gas path (HGP) components of gas turbines with district heating and process steam generation applications (plants without steam turbines) that use the same steam for NOX and power augmentation have a faster rate of performance degradation, when compared to gas turbines in combined cycle applications. In many of these units with district heating and process steam applications, there is undisputed evidence of corrosion attributable to low steam quality.

When steam is used for NOx abatement, the logic of the control system is generally designed to allow a limited amount of steam in order to mitigate over injection—a fixed percentage of the total turbine flow. Additional steam for power augmentation will only be permitted when the machine reaches base load. Then, additional steam is admitted via a governor control of the injection control valve.

However, injecting steam into a gas turbine combustor can be harmful. It increases the dynamics inside the combustor. Over time, increased dynamic pressure oscillations in the combustor increases the wear on the hot gas path parts (liners, seals, transition pieces, nozzles, etc.) causing premature wear on hot gas path parts. The net result is that maintenance intervals are decreased causing more frequent planned outages. Over injecting steam or injecting steam with unacceptable high levels of harmful components like sodium can cause increased damage to the turbine hot gas path components further reducing maintenance intervals and increasing parts fallout (rejection during the repair cycle).

As stated, gas turbine power plants without a steam turbine use steam produced by the boilers for NOx abatement or power augmentation. Without a steam turbine, the steam quality is linked to the process requirements, which is often subpar to the requirements for utilization in a turbine. In a combined cycle application, the common premise is that steam approved for a steam turbine will meet or exceed the minimum requirement for utilization in a gas turbine for NOx abatement and power augmentation. In both scenarios outlined there is no dedicated gas turbine control logic system responsible for assuring that the quality and purity of steam injected into the gas turbine is appropriate to protect the gas turbine from a higher rate than nominal performance and parts life degradation rate caused by hot corrosion of HGP components.

For steam turbine power plants there are steam analyzer systems that monitor the steam purity for controlling the chemical dosing of the boiler feed water. Systems based on the concept of monitoring feed water quality are available for boilers and steam turbines. However these systems do not prevent the admission of steam onto the turbine or feed water into the HRSG.

Accordingly, in units with steam used for power augmentation or NOx abatement, there is an opportunity to improve the steam quality and purity controls. Steam carries contaminants that can cause serious damage to hot gas path components if the levels at which they are present are not controlled. This improvement will promote better parts lives (by mitigating hot corrosion induced by sodium and other impurities above certain concentration levels carried over with the steam) and sustain performance. Controls and protective permissive can protect the power train from damage.

### BRIEF DESCRIPTION OF THE DISCLOSURE

Embodiments of the present disclosure are disclosed that can provide mitigation of hot corrosion in steam injected gas turbines. Certain embodiments of the disclosure can provide for the automatic injection or inhibit the injection of steam for NOx abatement and power augmentation in a gas turbine.

In one embodiment, the method can include obtaining an indication of steam purity or steam quality, obtaining steam purity injection requirement or steam quality injection requirement of a gas turbine, and determining whether the steam purity meets the steam purity injection requirement or the steam quality meets the steam quality injection requirement. In response to the determination of whether the steam purity meets the steam purity injection requirement or the steam quality meets the steam quality injection requirement, automatically sending a signal to a valve. The valve is operable to allow or inhibit a flow of steam into a component of the gas turbine system.

The signal automatically causes actuation of the valve to inhibit injection of steam into the component of the gas turbine system upon the determination that the steam purity does not meet the steam purity injection requirement or the steam quality does not meet the steam quality injection requirement. Alternately, the signal causes actuation of the valve to allow injection of steam into the component of the gas turbine system upon the determination that the steam purity meets the steam quality injection requirement and the steam quality meets the steam quality injection requirement.

In another embodiment, a gas turbine system comprises a steam analyzer that obtains steam purity information or steam quality information, a controller that compares the steam purity information or steam quality information to allowable limits, and the controller provides a signal whether the allowable limits are met for use in the gas turbine system.

In yet another embodiment, a gas turbine system comprises a combustor, a compressor discharge casing coupled to the combustor, and a sensor operable to obtain indications of dynamic oscillation in the combustor. A controller is configured to control a first valve and a second valve. The first valve is operable to inject a first steam flow into the compressor discharge casing and the second valve is operable to inject a second steam flow into the combustor. The controller modulates the first steam flow and the second steam flow to optimize a total steam flow while maintaining the indication of dynamic oscillation within acceptable limits.

Other embodiments and aspects will become apparent from the following description taken in conjunction with the following drawings.

### BRIEF DESCRIPTION OF THE DRAWINGS

Certain implementations with reference to the accompanying drawings are shown.

FIG. 1 illustrates a functional block diagram of a representative embodiment of a gas turbine system constructed in accordance with an embodiment of the disclosure.

FIG. 2 illustrates a functional block diagram of a steam injection control system constructed in accordance with an embodiment of the disclosure.

FIG. 3 illustrates by way of a block diagram an exemplary logic diagram of a steam analyzer control system in accordance with an embodiment of the disclosure.

FIG. 4 illustrates a functional block diagram of a representative embodiment of a steam injection controller in accordance with an embodiment of the disclosure.

FIG. 5 illustrates a flow diagram for injection of steam into a gas turbine system in accordance with an embodiment of the disclosure.

These implementations will now be described more fully below with reference to the accompanying drawings, in which various implementations and/or aspects are shown. However, various aspects may be implemented in many different forms and should not be construed as limited to the implementations set forth herein. Like numbers refer to like elements throughout.

### DETAILED DESCRIPTION OF THE DISCLOSURE

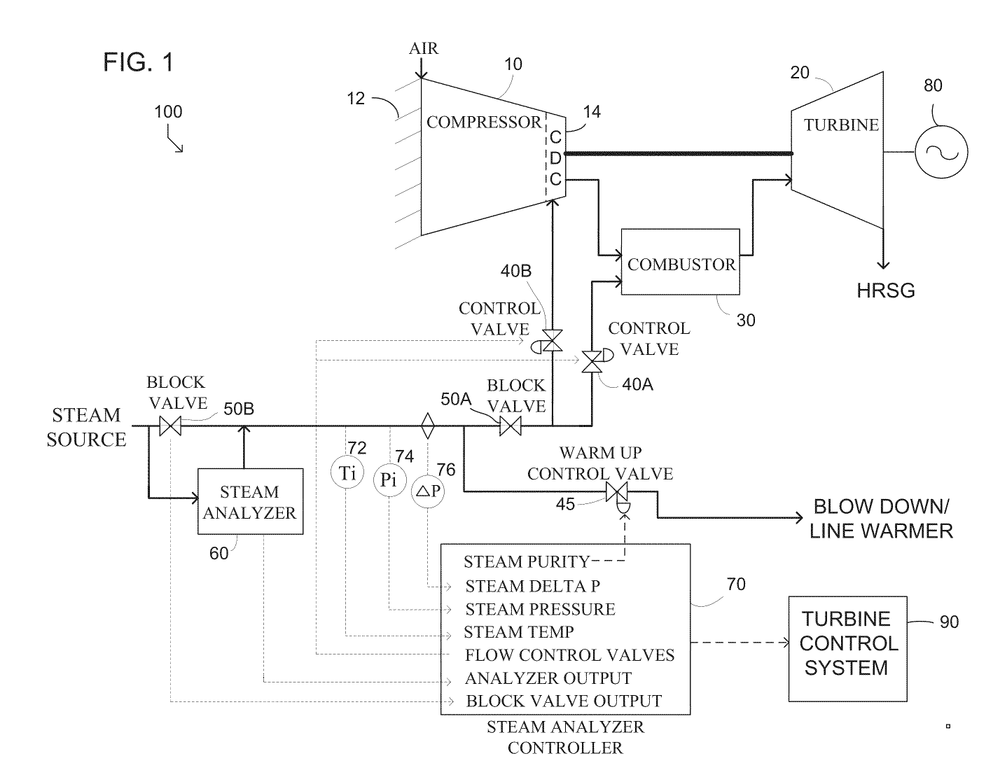

Referring to FIG. 1 of the drawings, there is shown a functional block diagram of a representative embodiment of a gas turbine system constructed in accordance with the present disclosure. In the illustrated embodiment, the gas turbine system 100 can include a gas turbine 20 which may drive an electric generator 80. Based upon chemical analysis of the steam purity and quality, a block valve 50A may inhibit injection of steam that does not meet allowable limits from entering the combustor 30 or the compressor 10.

The compressor 10 can compress the incoming air to high pressure. Air can enter the compressor 10 by way of a variable inlet guide vane mechanism 12 which controls the degree of opening of the turbine air intake and is used to adjust air flow during the startup phase to increase part load efficiency. The combustor 30 can mix the air with fuel and burns the fuel to produce high-pressure, high-velocity gas. The hot combustion gases can flow across a turbine 20 causing it to rotate converting the energy from the hot gases into mechanical energy. This mechanical energy may be used with a generator 80 for producing electricity or with other systems for other applications that are well known in the art.

After expanding in the turbine 20, the hot gases, although now considerably reduced in temperature and pressure, still contain a substantial amount of energy. Therefore, the hot gases may be conducted to a heat recovery steam generator (HRSG). The steam used for injection may be produced from treated demineralized water in a HRSG by using the heat entrained in the hot exhaust gases. Typically, the steam is produced primarily for industrial processes or district heating. Some of the steam may be diverted for injection into the combustion chamber 30 or in the compressor discharge 14. A block valve 50B can be operable to enable steam to enter and be used within the gas turbine system 100. The injected steam can cool the flame reducing the production of NOx and increasing the turbine mass flow thereby increasing power output.

A steam analyzer 60 can analyze the steam purity and quality. The analyzer 60 can obtain chemical information about the steam purity, including sodium, sodium based solid products and other carried over components in the supplied steam. It should be noted that corrosion may generally occur only if sodium is present together with chlorides or hydroxide anions. Chlorides and hydroxides are corrosive, not the sodium. The latter can serve as the carrier. Sodium measurement can be relatively effective in achieving accurate and rapid response at any time to detect hydroxides and chlorides. In this embodiment, this information on steam purity and quality and quality may be provided to a steam analyzer controller 70.

A warm up control valve 45 may provide access to a blow down path if the steam is not meeting standards. The warm-up line is also used during plant startup to warm-up the steam lines. During plant startup, steam generated is typically of a quality and purity that does not meet the required standards for use by turbines. It is normal to have high blow down rates to remove sediments and entrained carryover components. In addition, cold steam lines will reduce the quality of the steam. If this low quality and purity steam is introduced to the gas turbine, lasting damage can occur.

The steam analyzer controller 70 may determine if the amount of sodium products or other undesirable products present are in excess of the limits for steam approved for use in a gas turbine for NOx abatement or power augmentation. The desired turbine operation such as NOx abatement or power augmentation may be provided by a human machine interface (HMI). In addition to steam purity, the steam analyzer controller 70 can receive steam quality information such as steam temperature information from a temperature gauge 72 and pressure information form a pressure gauge 74. Steam pressure drop may be obtained indication from an associated indicator 76. A significant pressure drop may indicate a problem within the system 100.

If the quality or purity of steam does not meet desired standards, a block valve 50A and control valves 40A, 40B can be closed by a signal from steam analyzer controller 70 or the turbine control system 90, which is at least one technical effect associated with an embodiment of the invention. The steam may be diverted into a blowdown line by opening the warm-up control valve 45. This may prevent low purity or quality steam from causing damage the system 100, which is at least one technical effect or solution of certain embodiments of the disclosure.

Based upon the inputs, the steam analyzer control system 100 can determine if the steam purity and quality is within limits. The steam analyzer controller 70 can recommend based upon the chemical and quality information whether the steam can be injected. If steam can be injected, the steam analyzer controller 70 may send a permissive signal to allow the block valve 50A and control valves 40A, 40B to open, which is at least one technical effect associated with an embodiment of the invention. The steam analyzer controller 70 may provide a turbine controller signal to control the open position of the control valve 40A to regulate the combustion flame temperature to reduce the formation of NOx and power augmentation. The steam analyzer controller 70 also may provide signals to a control valve 40B to control the steam injection into the compressor discharge casing (CDC) 14 of the combustion turbine system 100 for additional power augmentation.

The system 100 described above with reference to FIG. 1 is provided by way of example only. As desired, a wide variety of other embodiments, systems, components, and methods may be utilized to detect the quality and purity of steam, and transmit signals to a plurality of block valves and control valves based upon the determined steam purity and quality.

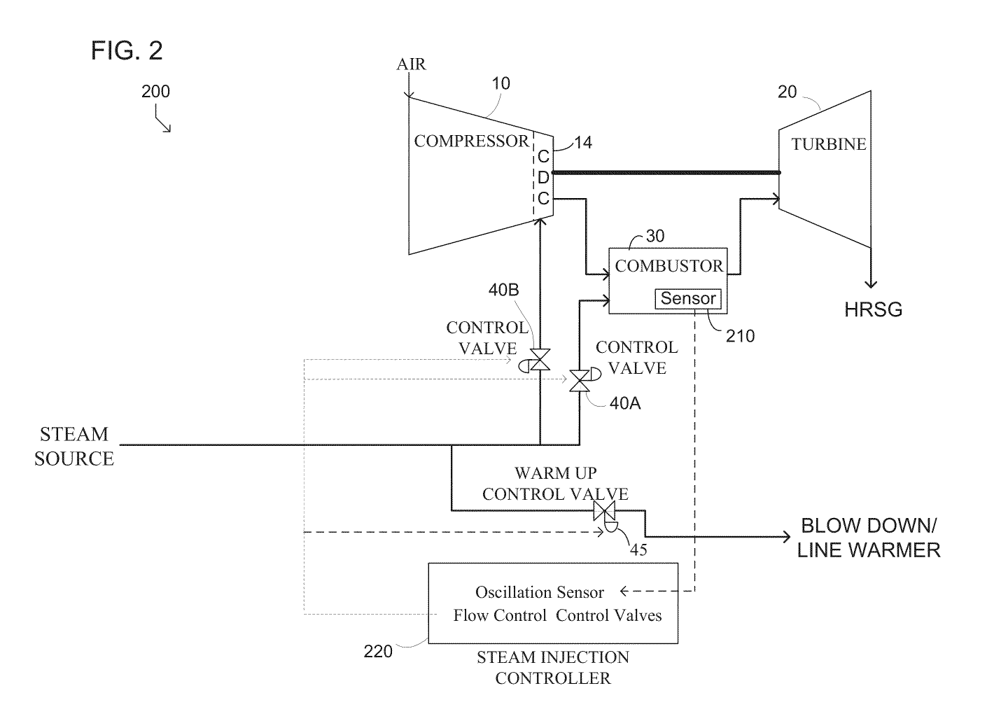

FIG. 2 illustrates a functional block diagram of a steam injection control system 200 constructed in accordance with an embodiment of the disclosure. In the illustrated embodiment, the steam injection control system 200 can balance the input of steam entering the combustor 30 or the compressor 10 and can prevent over injection of steam, which is at least one technical effect associated with an embodiment of the invention.

The compressor 10 can compress the incoming air to high pressure. The combustor 30 can mix the air with fuel and can burn the fuel to produce high-pressure, high-velocity gas. The hot combustion gases can flow across a turbine 20 causing it to rotate converting the energy from the hot gases into mechanical energy.

Over injection of steam can be harmful. A sensor 210 may be placed on the combustor 30 to detect vibrations. Increased vibration can indicate increased dynamic pressure oscillations. Injecting steam into the combustor 30 is a commonly used method to achieve the dual benefits of power augmentation and NOx abatement. However, reduction of the combustor temperature can have diminishing returns for NOx abatement below a certain threshold temperature. At that point, steam injection may primarily be injected for power augmentation.

The steam injection controller 220 may modulate steam injection between the CDC 14 and Combustor 30, which is at least one technical effect associated with an embodiment of the invention. The steam injection controller 220 may inject steam into the combustor 30 by sending a permissive that opens the control valve 40A. If the sensor 210 detects an increase or unacceptable level of vibrations, the controller 220 may limit the steam injection by throttling back on the opening of the control valve 40A.

Additional steam primarily for power augmentation may be injected into the CDC 14 by opening control valve 40B. If the sensor 210 detects an increase or unacceptable level of vibrations, the controller may limit the steam by throttling back on the opening control valve 40B.

The warm up control valve 45 may be adjusted to regulate the discharging of excess steam that is not required for NOx abatement or power augmentation. By modulating the steam injection between the CDC 14 and combustor 30, the steam controller may be able to enhance the steam injection into the system 200 while minimizing harmful dynamic pressure oscillations, which is at least one technical effect associated with an embodiment of the invention.

The system 200 described above with reference to FIG. 2 is provided by way of example only. As desired, a wide variety of other embodiments, systems, components, and methods may be utilized to detect harmful over injection of steam and transmit signals to a plurality of control valves and block valves to modulate the injection of steam into a gas turbine thereby constituting a protection system.

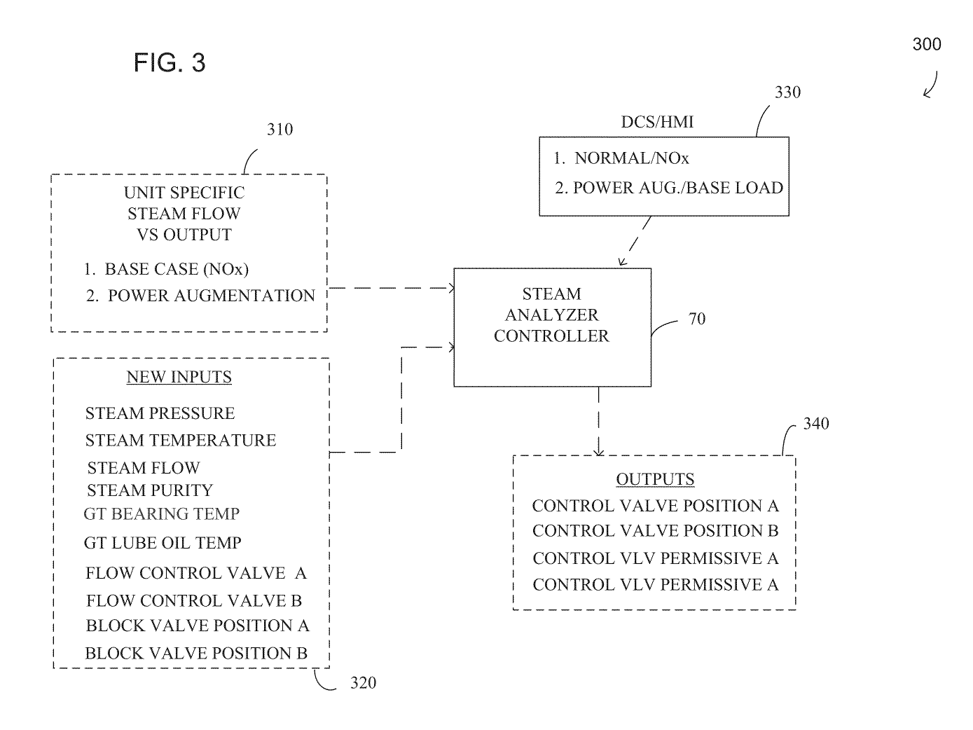

FIG. 3 illustrates by way of a block diagram an exemplary logic diagram 300 of a steam analyzer controller 70. The controller 70 determines if the amount of sodium, sodium based solid products, and other carried over components in the supplied steam present are in excess of the limits for steam approved for use in a gas turbine for NOx abatement or power augmentation. The steam analyzer controller can then recommend based upon the chemical information and quality whether the steam can be injected.

The desired turbine operation such as NOx abatement for normal operations or power augmentation for base load operation may be provided by a human machine interface (HMI) 330. Unit specific information 310 such as steam flow versus power output based on the selected normal operations or base load operations, may be inputted. The steam flow into the gas turbine system may be increased if more power is desired or throttled back if sensors detect harmful dynamic oscillations.

Operational inputs may also be automatically provided online to the controller 70. From inline gauges, the controller may receive steam quality information such as steam temperature information, steam pressure information, and steam pressure drop indication. Steam quality and purity may be provided by an inline steam analyzer.

Information about the current state of the system such as gas turbine power output, lube oil temperature, gas turbine bearing temperature, lube oil flow, and the like may indicate that the system is cold and block valves that admit steam into the gas turbine system may need to be in a closed position until the system reaches a base load operating status.

Based upon the inputs, the steam analyzer controller 70 can determine if the steam purity and quality is within limits. This controller 70 may recommend based upon the chemical and steam quality information whether the steam may be injected. The controller may provide permissive signals to open the block valves and provide the control valve positions as an output signal, which is at least one technical effect associated with an embodiment of the invention.

If the quality or purity of steam does not meet desired standards, block valves can be automatically closed by an output signal from the controller and the warm up control valve can be opened to provide for blowdown of the steam. This action may prevent low purity or low quality steam from causing damage the system, which is at least one technical effect associated with certain embodiments of the invention.

The system 300 described above with reference to FIG. 3 is provided by way of example only. As desired, a wide variety of other embodiments, systems, components, inputs, and outputs may be utilized to detect the quality and purity of steam and transmit signals to a plurality of block valves and control valves based upon the determined steam purity and quality.

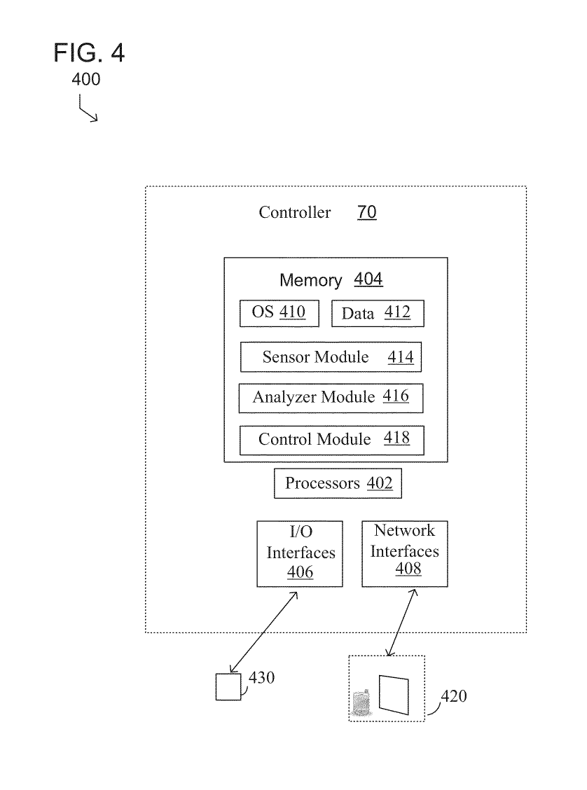

FIG. 4 illustrates a block diagram 400 of a steam injection controller 70 in accordance with an embodiment of the disclosure.

The steam injection controller 70 may comprise one or more processors 402, one or more memories 404, one or more input/output (“I/O”) interfaces 406, and one or more network interfaces 408. The steam injection controller 70 may include other devices not depicted.

The processor 402 may comprise one or more cores and is configured to access and execute at least in part instructions stored in the one or more memories 404. The one or more memories 404 comprise one or more computer-readable storage media (“CRSM”). The one or more memories 404 may include, but are not limited to, random access memory (“RAM”), flash RAM, magnetic media, optical media, and so forth. The one or more memories 404 may be volatile in that information is retained while providing power or non-volatile in that information is retained without providing power.

The one or more I/O interfaces 406 may also be provided in the steam injection controller 70. These I/O interfaces 406 allow for coupling devices such as sensors, displays, external memories, valve positioners, and so forth for the steam injection controller 70.

The one or more network interfaces 408 may provide for the transfer of data between the controller 70 and another device directly such as in a peer-to-peer fashion, via a network, or both. The network interfaces 408 may include, but are not limited to, personal area networks (“PANs”), wired local area networks (“LANs”), wide area networks (“WANs”), wireless local area networks (“WLANs”), wireless wide area networks (“WWANs”), and so forth. The network interfaces 408 may utilize acoustic, radio frequency, optical, or other signals to exchange data between the controller 70 and another device such as a smart phone, an access point, a host computer and the like.

The one or more memories 404 may store instructions or modules for execution by the processor 402 to perform certain actions or functions. The following modules are included by way of illustration, and not as a limitation. Furthermore, while the modules are depicted as stored in the memory 404, in some implementations, these modules may be stored at least in part in external memory which is accessible to the controller 70 via the network interfaces 408 or the I/O interfaces 406. These modules may include an operating system module 410 configured to manage hardware resources such as the I/O interfaces 406 and provide various services to applications or modules executing on the processor 402.

A sensor module 414 may be stored in the memory 404. The sensor module 414 may be configured to acquire sensor data from the one or more sensors 430. The sensor module 414 may be configured to obtain steam temperature information, steam pressure information, pressure drop information, gas turbine lube oil temperature, gas turbine bearing temperature, block valve positions, control valve positions, vibration information, sodium concentration and other purity information, and the like. The sensor module 414 may store the sensor data in the datastore 412.

An analyzer module 416 may be stored in the memory 404. The analyzer module 416 may be configured to determine the steam quality and purity. The steam quality may be determined inputted to the controller 70 from an inline analyzer or calculated using collected steam parameter information. Steam purity information may be obtained from an inline purity analyzer. The analyzer module 416 may compare the purity and quality information to allowable limits. Based upon the results, the analyzer module 416 may recommend the injection of steam.

A control module 418 may be stored in the memory 404. The control module 418 may be configured to transmit and receive permissive signals and valve positions. The control module 418 may obtain plant status information to determine if block valves may be opened to allow steam into the gas turbine system. Plant status information such as gas turbine power output, lube oil temperature, lube oil flow information, gas turbine bearing temperature, output power, and the like may provide information to determine if the plant is at base load and steam injection may be initiated for NOx abatement or power augmentation. Based upon the determined quality and purity information, the control module 418 may transmit permissives to open block valves to allow steam to enter in the gas turbine system. The control module may also transmit control valves positions to allow steam to enter the CDC and combustor. Based upon collected vibration information, the control module 418 may throttle back the steam injection into either the CDC or combustor until the vibration detection is within acceptable limits, which is at least one technical effect associated with an embodiment of the invention. The control module 418 may try to modulate the steam flow into the CDC and combustor to find a maximum acceptable steam injection. Increasing the turbine's mass flow increases its power output.

The controller system 400 described above with reference to FIG. 4 is provided by way of example only. As desired, a wide variety of other embodiments, systems, components, and methods may be utilized to detect the quality and purity of steam and transmit signals to a plurality of block valves and control valves based upon steam purity, quality, and dynamic pressure oscillations.

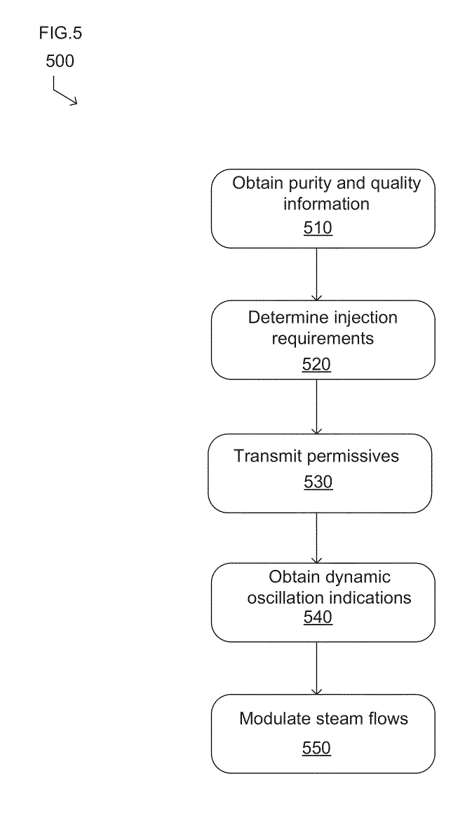

FIG. 5 illustrates a flow diagram for injection of steam into a gas turbine system in accordance with an embodiment.

In step 510, the steam injection system can obtain steam purity and quality information. The information can be obtained from sensors may include steam temperature information, steam pressure information, pressure drop information, gas turbine lube oil temperature, gas turbine bearing temperature, and the like. The system may obtain the amount of sodium, sodium based solid products, and other carried over components in the supplied steam from an inline purity analyzer. In addition, the system may obtain gas turbine system information such as current block valve positions, control valve positions, and the like.

In step 520, the steam injection system can obtain the allowable limits for the steam purity and quality. These limits may be rule based and typically are predetermined. The system can compare the actual steam purity and quality to the allowable limits.

In step 530, the steam injection system can determine if the steam quality and purity meet the allowable limits. If the allowable limits are met, the system may generate permissives to actuate block and control valves to allow steam to be injected into the gas turbine system, which is at least one technical effect associated with an embodiment of the invention. If NOx abatement is desired, the steam may be injected into the combustor. If additional power augmentation is desired, the steam may be injected into the compressor discharge casing. The system may provide the applicable control valve positions for the injection of steam.

In step 540, the steam injection system can obtain indications of dynamic oscillations within the combustor. These indications may be obtained from various sensors including vibration sensors.

In step 550, the steam injection system may compare the dynamic oscillation indications to an allowable limit. If the allowable limit is exceeded, the system may throttle the control valves to reduce the steam flow until the sensors indicate acceptable limits are being maintained. The system may actuate a control valve to either the combustor or the compressor discharge casing to enhance the steam injection while ensuring the dynamic oscillation limits are not exceeded, which is at least one technical effect associated with an embodiment of the invention. The method 500 can repeat until steam injection is no longer desired.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by processor-executable program instructions. Likewise, some blocks of the block diagrams and flow diagrams may not necessarily need to be performed in the order presented, or may not necessarily need to be performed at all, according to some implementations.

These processor-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method for injection of steam into a gas turbine system comprising:
obtaining an indication of steam purity or steam quality;
obtaining at least one of steam purity injection requirement or steam quality injection requirement of a gas turbine;
determining whether the steam purity meets the steam purity injection requirement or the steam quality meets the steam quality injection requirement; and
in response to a determination whether the steam purity meets the steam purity injection requirement or the steam quality meets the steam quality injection requirement, automatically sending a signal to a valve; wherein the valve is operable to allow or inhibit a flow of steam into a component of the gas turbine system.

2. The method of claim 1, wherein the signal automatically actuates the valve to inhibit injection of steam into the component of the gas turbine system upon the determination that the steam purity does not meet the steam purity injection requirement or the steam quality does not meet the steam quality injection requirement.

3. The method of claim 1, wherein the signal automatically actuates the valve to allow injection of steam into the component of the gas turbine system upon the determination that the steam purity meets the steam quality injection requirement and the steam quality meets the steam quality injection requirement.

4. The method of claim 1, wherein the component of the gas turbine system is a gas turbine combustor or a gas turbine compressor discharge casing.

5. A gas turbine system comprising:
a steam analyzer that obtains steam purity information or steam quality information; and
a controller that compares the steam purity information or steam quality information to allowable limits, wherein the controller provides a signal whether the allowable limits are met for use in the gas turbine system.

6. The system of claim 5 further comprising a control system that inhibits the injection of steam into a component of the gas turbine system based on the signal indicating that the steam does not meet the allowable limits.

7. The system of claim 5 further comprising a control system that allows the injection of steam into a component of the gas turbine system based on the signal indicating that the steam meets the allowable limits.

8. The system of claim 5, wherein the component of the gas turbine system is a gas turbine combustor or a gas turbine compressor discharge casing.

9. The system of claim 5, wherein the purity information includes an amount of sodium in the steam.

10. The system of claim 5, wherein the purity information includes an amount of sodium based solid in the steam.

11. The system of claim 5, wherein the purity information includes an amount of sodium entrained solid carry over components in the steam.

12. The system of claim 5, wherein the use in the gas turbine is NOx abatement.

13. The system of claim 5, wherein the use in the gas turbine is power augmentation.

14. A gas turbine system comprising:
a combustor;
a compressor discharge casing coupled to the combustor;
a sensor operable to obtain indications of dynamic oscillation in the combustor;
a first valve operable to inject a first steam flow into the compressor discharge casing;
a second valve operable to inject a second steam flow into the combustor;
a controller configured to control the first valve and the second valve, wherein the controller modulates the first steam flow and the second steam flow to enhance a total steam flow while maintaining the indication of dynamic oscillation within acceptable limits.
